(19) United States
(12) Patent Application Publication
(10) Pub. No.: US 2016/0169164 A1
(43) Pub. Date: Jun. 16, 2016

(54) NATURALLY ASPIRATED COMMON RAIL DIESEL ENGINE MEETING ULTRA LOW PM EMISSION BY PASSIVE EXHAUST AFTER TREATMENT

(71) Applicant: MAHINDRA & MAHINDRA LTD., Chennai (IN)

(72) Inventors: R VELUSAMY, Chennai (IN); DIPANKAR RAY, Chennai (IN); BHOSALE SADANAND, Chennai (IN); HIRANANDANI PRAVESH, Chennai (IN); RANE SANTOSH, Chennai (IN); R SURESH, Chennai (IN); DALVI ATMARAM, Chennai (IN); S DEEPAK, Chennai (IN)

(21) Appl. No.: 14/907,234

(22) PCT Filed: Jul. 23, 2014
(86) PCT No.: PCT/IN14/00486

§ 371 Date: Jan. 22, 2016

(30) Foreign Application Priority Data
Jul. 23, 2013 (IN) 3271/CHE/2013

(51) Int. Cl. F02M 26/15; F01N 3/20; F02M 26/19; F01N 3/10

(52) U.S. Cl. CPC F02M 26/15; F01N 3/10; F01N 3/20; F02M 26/19

(57) ABSTRACT

A system (100) for controlling emissions of exhaust gases in said naturally aspirated engine is disclosed. The system includes an open loop exhaust gas recirculation flow. The system (100) further includes a catalyst (102) mounted at exhaust manifold (106) of the engine. Furthermore the system (100) includes an exhaust gas mixing tube inserted into intake elbow (104) (mixing tube). The system (100) further includes an exhaust gas recirculation valve (110) mounted on cold side of EGR cooler. Furthermore, the system (100) includes an electronic control unit to control exhaust gas recirculation valve (110) along with various other engine calibration parameters.

### CROSS REFERENCES TO RELATED APPLICATIONS

The present application is a national phase application of international application number. PCT/IN2014/000486, filed on 23 Jul. 2014 which claims priority from, IN Application Number 3271/CHE/2013 filed on 23 Jul. 2013, the disclosure of which is hereby incorporated by reference herein.

### FIELD OF INVENTION

The embodiments herein relate to emission control system for an internal combustion engine, and more particularly, to method and system for internal combustion engines which will minimize NOx and other emissions while minimizing particulate matter emissions from internal combustion engines.

### BACKGROUND OF INVENTION

The catalytic treatment of various gaseous streams containing minor amounts of materials which are considered to be atmospheric pollutants such as hydrocarbons, carbon monoxide and nitrogen oxides has been practiced on a commercial basis for a number of years. It is desired to convert these pollutants to the less noxious materials, carbon dioxide, water and nitrogen. Generally, the gaseous streams which are treated are effluent or waste gas streams which are discharged into the atmosphere in large quantities, and a salient example of such treatments is the high temperature contact of the exhaust gases of internal combustion engines with a catalyst loaded with precious metals like Palladium (Pd), Platinum (Pt), Rhodium (Rh) etc. Initially, most attention was directed on a commercial basis to the oxidation of the hydrocarbon and carbon monoxide components of the gaseous streams, and generally the treating system contained an excess of oxygen based on complete combustion of these components to carbon dioxide and water. Since the catalysts employed also had a capability of promoting reduction reactions, there may have occurred during the treatment some reduction of nitrogen oxides into nitrogen and/or ammonia, although the presence of the latter material in the products is undesirable.

Further exhaust gas re-circulation is a technique commonly used for controlling the generation of undesirable pollutant gases in the operation of internal combustion engines. This technique has proven particularly useful in internal combustion engines used in motor vehicles such as passenger cars, light duty trucks, and other on-road motor equipment. The exhaust gas re-circulation technique primarily involves the re-circulation of exhaust gas byproducts into the intake air supply of the internal combustion engine. This exhaust gas thus reintroduced to the engine cylinder reduces the concentration of oxygen therein, which in turn lowers the maximum combustion temperature within the cylinder and slows the chemical reaction of the combustion process, decreasing the formation of nitrous oxide. Furthermore, the exhaust gases typically contain a portion of unburned hydrocarbon which is burned on its reintroduction into the engine cylinder, which further reduces the emission of exhaust gas byproducts which would be emitted as undesirable pollutants from the internal combustion engine.

Further, at present a number of exhaust gas-treating systems containing a plurality of catalysts have been proposed, and the operations often involve the use of one catalyst under reducing conditions to maximize the conversion of nitrogen oxides to nitrogen, and a separate catalyst is employed under oxidizing conditions to maximize the conversion of carbon monoxide and hydrocarbons to carbon dioxide and water. Such, systems are expensive and, therefore, undesirable, particularly where the amount of space available for containing the catalytic equipment is limited as is usually the case with Off-Highway Vehicles. However, as time passes the levels of pollutants that may be charged acceptably into the atmosphere are being lowered to the extent that both the oxidation of carbon monoxide and hydrocarbons and the reduction of nitrogen oxides must be accomplished to a high degree if government regulations are to be satisfied. It is, therefore, quite important to develop catalytic systems for treating such gases most effectively and under economically attractive conditions.

### OBJECT OF INVENTION

The principal object of this invention is to provide an emission control system for a naturally aspirated common rail diesel engine with a diesel oxidation catalyst in exhaust gas flow path.

Another object of the invention is to provide an open loop Exhaust Gas Recirculation system for controlled supply of exhaust gas to an intake of the naturally aspirated diesel engine.

A further object of the invention is to provide an emission control system which will optimize field fuel consumption with good drivability while concurrently minimizing emissions such as nitrous oxide and minimizing the release of undesirable particulate matter.

Another object of the present invention is to provide an emission control system which will provide more accurate control over the exhaust gas re-circulation.

Yet another object of the invention is to provide a method of controlling emission of a naturally aspirated diesel engine by providing a diesel oxidation catalyst in exhaust gas flow path.

These and other objects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### SUMMARY

Accordingly a system for controlling emissions of exhaust gases in a common rail naturally aspirated engine having DOC in after treatment with an open loop control of injected fuel and exhaust gas recirculation flow (EGR) is disclosed. The system comprises integration of close coupled diesel oxidation catalyst (DOC) on exhaust manifold and EGR path is connected between exhaust and intake side by EGR pipe. EGR gas enters into intake elbow through a mixing tube which facilitates uniform mixing of EGR gas with fresh air and this homogenous charge enters individual cylinder ports. The system further includes an Electronic Exhaust Gas Recirculation valve (EEGR) which controls exhaust gas flow based on optimized EGR map by Electronic Control Unit (ECU) of the engine.

Also, a method for controlling emissions of exhaust gases in a naturally aspirated engine having an open loop EGR control is disclosed. The method includes mapping an injected fuel quantity and demanded EGR valve position as function of engine speed & Throttle Demand. Actual EEGR valve position is controlled by a position feedback mechanism. Here the system works as an open loop system where emission control is done through calibrated base and/or corrections maps. The correction maps are selected based on engine coolant temperature.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts a layout of a typical engine intake, exhaust system with DOC & EGR system according to embodiments as disclosed herein;

FIG. 2 depicts an arrangement of an EGR mixing tube inserted in to an intake manifold according to an embodiment disclosed herein;

FIG. 3 illustrates a perspective view of complete system according to an embodiment disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. For example, it should be noted that while some embodiments are explained with respect to a system for controlling emissions of naturally aspirated engine using a catalyst, any other engine may also incorporate the subject matter of the invention with little or no modifications. Accordingly, the examples should not be construed as limiting the scope of the embodiments herein.

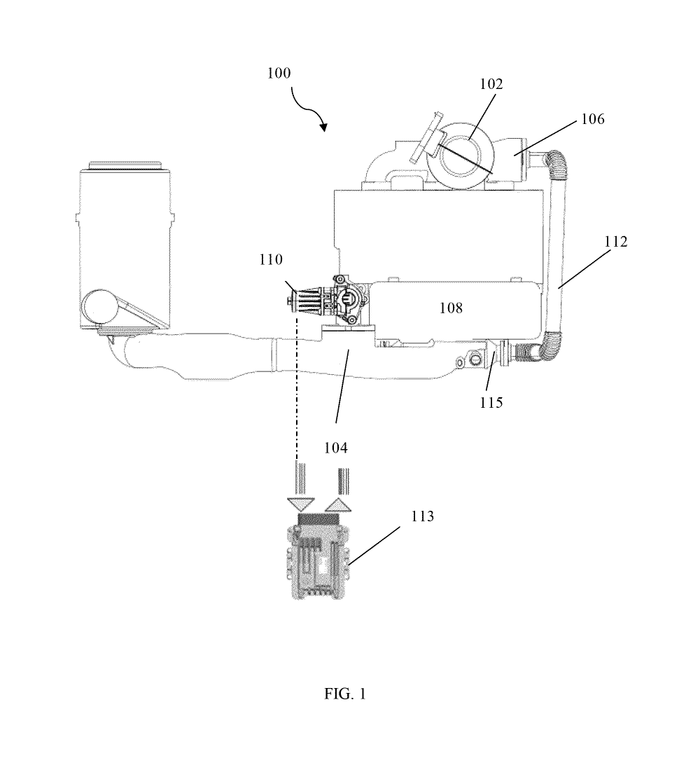

The embodiments herein achieve an emission control system (100) for a naturally aspirated diesel engine by providing a diesel oxidation catalyst (102) in exhaust gas flow path as described herein below. The embodiments herein achieve an emission control system (100) with optimum field fuel consumption and good vehicle drivability while concurrently minimizing emissions such as nitrous oxide and minimizing the release of undesirable particulate matter. The embodiments herein achieve a method of controlling emission of a naturally aspirated diesel engine by providing a diesel oxidation catalyst (102) in exhaust gas flow path. Referring now to the drawings, and more particularly to FIGS. 1 through 3, where similar reference characters denote corresponding features consistently throughout the figures, there are shown embodiments.

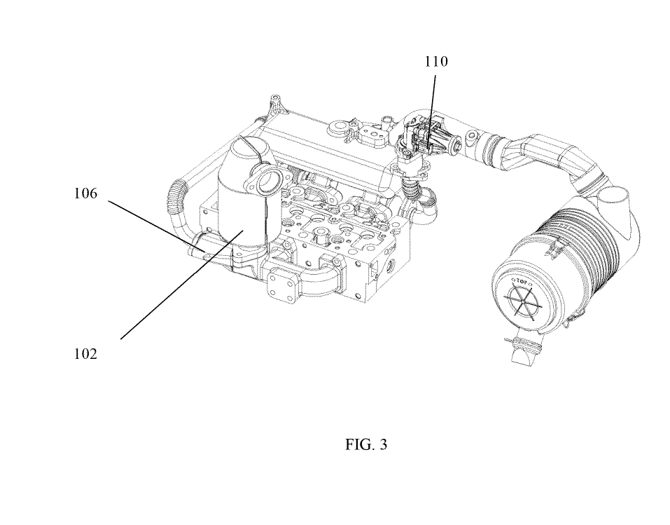

FIGS. 1 and 3 depicts a typical engine breathing, exhaust and EGR system (100) according to embodiments as disclosed herein. The system (100) includes an air intake manifold (108), an air intake elbow (104), an exhaust manifold (106), an exhaust gas pipe (112), an EGR mixing tube (114), an exhaust gas recirculation (EGR) valve (110) and an electronic control unit (ECU) (113). In an embodiment the engine includes an intake air flow path, which is typically an air cleaner, intake elbow and intake manifold, and an exhaust gas flow path for exhaust gases. The EGR pipe (112) connects the exhaust manifold (106) and EGR Cooler (115) which is connected to air intake elbow (104). The EGR valve (110) is operatively positioned in a known manner on intake elbow (104) and controls the EGR flow. The EGR flow control is open loop. The mixing tube (114) inserted into intake elbow facilitates uniform mixing of EGR gas in to fresh air uniformly and there by charging individual cylinder heads homogenously. The EGR valve (110) opening is based on calibrated EGR map controlled through ECU to maintain the level of particulates emitted in the exhaust gas within prescribed limits. The electronic control unit specifically includes open loop control logic to provide a regulated flow of EGR into the intake elbow (104) and injected fuel quantity control depending on engine speed, throttle demand, coolant temperature & atmospheric pressure etc.

For engine out emission control, a suitable compression ratio is selected. The bowl shape, Injector nozzle, injection pressures, injections parameters and cylinder head swirl are chosen after studying interaction effect with intention to minimize engine out emissions. The Volatile organic fractions of engine out emissions are further oxidized in DOC. Tail pipe emissions under steady state (NRSC), NTE and transient cycle (NRTC) are controlled by combination of engine hardware and with calibration of injection parameters and EGR rate. Corrections in base map are done based on coolant temperature and ambient pressure. Emission control is achieved with open loop system.

The base engine must have sound mechanical design. The oil consumption control and Positive crankcase ventilation design is appropriate to control volatile oil fractions in exhaust emission. For engine out HC control, a suitable compression ratio is selected.

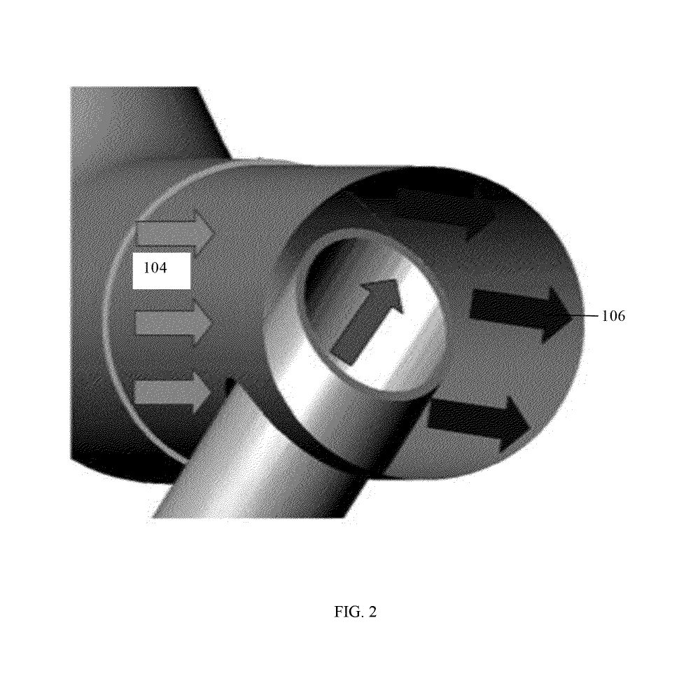

FIG. 2 depicts an arrangement of the EGR mixing tube (114) provided in to intake elbow (104). The intake elbow with mixing tube is designed to achieve homogeneous mixture of fresh air with exhaust gas. The EGR Valve (110) connected to the intake elbow operates based on the signal obtained from the ECU.

Those skilled in the art will recognize that additional components are typically included in such an engine as is exemplified herein. Other apparatus associated with such an engine includes engine systems like lubrication, cooling, power train, gear train, valve train, structural etc. It is believed that those skilled in the art are well acquainted with such apparatus and will be readily able to select such apparatus as is necessary to the satisfactory construction and operation of an engine. No particular form of type of such associated apparatus is necessary to the operation of the engine other than that which is commonly employed in the art, and therefore such apparatus is not further discussed herein. Furthermore, of course, the subject invention is to be understood as applicable with equal suitability to multiple cylinder engines. Therefore, the engine as set forth herein should be considered as exemplary and not limiting. Further the engine used in this exemplary is a common rail injection system.

In accordance with another aspect of the present invention, an EGR cooler (115) is disposed between intake elbow (104) and EGR pipe (112) for cooling the engine exhaust gases before the exhaust gases reach the EGR valve (110).

In an embodiment the electronic control unit is provided in communication with the engine and its operations. The electronic control unit, as is known to those skilled in the art, will typically contain means for controlling the operation of the engine in response to sensed measurements of various operating parameters of the engine as provided to the electronic control unit by various sensors disposed on and in conjunction with the engine. As it relates to the present invention, the electronic control unit is provided with a means for sensing the operating speed and load of the engine by way of the crankshaft, typically an engine operation sensor for indicating the instant rotational speed in terms of revolutions per minute of the engine crankshaft, such as is known to those skilled in the art. The electronic control unit is also adapted for controlling the fuel injector to control the quantity, timing, and duration of fuel injected into the combustion chamber of the engine.

An EGR valve position feedback and a Valve closed position learning is incorporated in engine calibration logic. The coolant temperature based corrections in ECU base map are done for cold NRTC & cold ambient engine start. Engine safety functions like over heat protection, over speed protection, over run monitoring etc., are activated since such flexibility is available with ECU controlled Common rail engine.

In an embodiment, a diesel oxidation catalyst (102) (DOC) is mounted on exhaust manifold (106) to oxidize organic volatile fractions from engine out emissions. This oxidation reaction in DOC helps to reduce tail pipe HC and CO emissions as well it reduces PM due to oxidation of volatile organic fractions. The close coupled DOC mounted on Exhaust manifold helps for faster activation of DOC even at light loads. A combination of Precious metals (Pt+Pd) in right proportion and loading ensures meeting legal emission demand over the entire useful life of the engine. The normal exhaust gas temperature for Naturally Aspirated diesel engine is 200-650 deg C. The light-off temperature of DOC is around 250 deg C. Palladium gives better thermal stability at high gas temperature operation where as Platinum helps for faster activation at light load. For this application, a predetermined Pt:Pd combination is used for controlling the PM emissions throughout the engine operation.

In an embodiment a transient calibration is performed on said engine to get optimum NOx/PM trade off throughout the engine map meeting the cycle BSFC targets. Further in an embodiment Rail pressure, Start of main injection. Start of pilot injection and the quantity. EGR rate over entire engine map, and Water temperature based corrections in EGR flow rate are tuned to calibrate the engine.

Further those skilled in the art will recognize that additional operating parameters are typically included in such an engine as is exemplified herein. Other operating parameters associated with such an engine include proper design and integration of sub-systems, selection of hardware and optimization of Injection parameters. It is believed that those skilled in the art are well acquainted with such apparatus and will be readily able to select such operating parameters as is necessary to the satisfactory construction and operation of an engine. No particular form of type of such associated parameters is necessary to the operation of the engine other than that which is commonly employed in the art, and therefore such apparatus is not further discussed herein. In embodiment Injector parameters like number of holes, Spray cone angle, Nozzle through Flow (NTF) and Nozzle Tip Protrusion (NTP) are selected based on smoke and BSFC. Further a piston of specific bowl shape having a predetermined compression ratio is selected for reducing the NOx/Soot trade-off. Further known High swirl intake port cylinder, valve operations and valve timing are kept standard. It can be seen that the subject invention provides a numerous advantages including a quick transient response of engine on dynamometer test as well in field operations. A transient smoke calibration is an open loop system.

An additional advantage is a superior control of the emission of undesirable exhaust gas byproducts from the exhaust gas discharge. Further this configuration can be adapted easily in existing vehicle layout which reduced substantial investment in vehicle development. Optimum selection of piston bowl shape. Injector, EGR valve, EGR cooler and DOC with optimum rail pressure, main injection timing & EGR maps over entire engine operation are the key factors for achieving this invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system (100) for controlling emissions of exhaust gases in an internal combustion engine having an open loop control of exhaust gas recirculation flow, said system (100) comprising:
a catalyst (102) closely coupled to exhaust manifold (106) of the engine having a passive Particulate Matter filter;
an exhaust gas mixing tube inserted into an intake elbow (104) (mixing pipe) for mixing exhaust gas with fresh air uniformly; and
an exhaust gas recirculation valve (110) integrated on cold side of EGR circuit;
wherein
said exhaust gas recirculation valve (110) consists of a position control mechanism to calculate required EGR rate depending on engine speed, throttle position and ambient pressure and coolant temperature conditions.

2. The system (100) as claimed in claim 1, wherein said catalyst (102) is selected from a group comprising of possible combination and loading of precious metal.

3. The system (100) as claimed in claim 1, wherein a common rail fuel injection system is used for injecting fuel.

4. The system (100) as claimed in claim 1, wherein an EGR cooler (115) is mounted upstream of the exhaust gas recirculation valve (110) for cooling the engine exhaust gases before it reach air intake elbow.

5. The system (100) as claimed in claim 1, wherein said system (100) meets Off High Way US EPA TIER-4(F) emission norms.

6. A method for controlling emissions of exhaust gases in a naturally aspirated engine having an open loop EGR comprising:
mapping an injected fuel quantity and demanded EGR valve position as function of engine speed & Throttle Demand; and
controlling EEGR valve position by a position feedback mechanism; wherein
said system works with an open loop EGR system where emission control is done based on calibrated base or corrections maps;
said correction maps are selected based on engine coolant temperature.
